(19) United States
(12) Patent Application Publication
(10) Pub. No.: US 2010/0303208 A1
(43) Pub. Date: Dec. 2, 2010

(54) METHOD FOR RECORDING AN X-RAY IMAGE, X-RAY DETECTOR AND X-RAY SYSTEM

(76) Inventors: Oliver Baruth, Erlangen (DE); Philipp Bernhardt, Forchheim (DE)

Correspondence Address: King & Spalding LLP, 401 Congress Avenue, Suite 3200, Austin, TX, 78701, US

(21) Appl. No.: 12/781,054

(22) Filed: May 17, 2010

(30) Foreign Application Priority Data
May 29, 2009 (DE) 10 2009 023 202.8

(51) Int. Cl. H05G 1/64

(52) U.S. Cl. 378/98.8

(57) ABSTRACT

To obtain a high-quality X-ray image from X-ray detectors with defective pixels, an X-ray image of an object is recorded by an active pixel matrix of an X-ray detector from at least two partial X-ray images, in which a first partial image is recorded from picture elements in a first position and at least one second partial image is recorded from picture elements in a second position of the pixel matrix, wherein the pixel matrix has at least one defective pixel at a defect site and the positions are selected such that
the active pixel matrix is situated in the same plane in all positions,
each displacement of the active pixel matrix from one into another position is an integer multiple of a pixel length, and
at least one non-defective pixel is positioned in at least one other position at the respective defect sites of all positions.

### CROSS-REFERENCE TO RELATED APPLICATIONS

This application claims priority to German Patent Application No. 10 2009 023 202.8 filed May 29, 2009, the contents of which is incorporated herein by reference in its entirety.

### TECHNICAL FIELD

The invention relates to a method for recording an X-ray image, and an X-ray detector and an X-ray system for carrying out such a method.

### BACKGROUND

The use of digital X-ray detectors with active pixel matrices, in particular so-called flat-panel detectors, in radiography presents the problem of the occurrence of, in general, a number of defective pixels within the active matrix. The number and arrangement of the defective pixels can be determined in a calibration step by generating a so-called defect-pixel map. The number and arrangement of the pixels are used to classify the X-ray detector into different defect classes, on the basis of which a decision is made, for example, as to whether a software correction (usually an interpolation) of the corresponding picture elements can be calculated or whether the X-ray detector has too many or too awkwardly placed defective pixels for a correction.

On the one hand, no medically relevant structures may be lost in an X-ray recording due to pixel errors (e.g. if the medically relevant detail just lies in a defective region and the correction calculates an interpolation on the basis of the region boundaries) and the software correction may not generate artifacts that could lead to wrong diagnoses, but on the other hand the manufacture of digital flat-panel detectors is such a complex area that the yield of defect-free detectors is very low. In conjunction with the high unit prices of the digital X-ray detectors, it is also necessary to use X-ray detectors with a plurality of defective pixels and to ensure clinical applicability by software correction algorithms.

### SUMMARY

According to various embodiments, a method for recording an X-ray image of an object can be provided, which allows reliable and high-quality imaging of the object, particularly in the case of X-ray detectors with an active pixel matrix with a plurality of defective pixels. Moreover, according to various embodiments, a suitable X-ray system and an X-ray detector for carrying out the method can be provided.

According to an embodiment, in a method for recording an X-ray image of an object by means of an active pixel matrix of an X-ray detector from at least two partial X-ray images, a first partial X-ray image is recorded from picture elements in a first position of the pixel matrix and at least one second partial X-ray image is recorded from picture elements in a second position of the pixel matrix, wherein the pixel matrix has at least one defective pixel at a defect site and wherein the positions are selected such that—the active pixel matrix is situated in the same plane in all positions,—each displacement of the active pixel matrix from one position into another position is an integer multiple of a pixel length, and—at least one non-defective pixel is positioned in at least one other position at the respective defect sites of all positions.

According to a further embodiment, a first partial X-ray image can be recorded from picture elements in a first position of the pixel matrix and a second partial X-ray image can be recorded from picture elements in a second position of the pixel matrix, wherein the two positions can be selected such that—the pixel matrix is situated in the same plane in both positions, —a displacement of the pixel matrix from the first position into the second position is an integer multiple of a pixel length, and—a non-defective pixel from the respective other position is positioned at the defect sites of both positions. According to a further embodiment, three or more partial X-ray images may be recorded. According to a further embodiment, the picture elements from the first and the second partial X-ray image can be superposed displaced by the displacement and are processed to form the X-ray image. According to a further embodiment, the processing of the partial X-ray images may only utilize the grayscale values of the non-defective pixels. According to a further embodiment, the processing of the partial X-ray images may perform an averaging of the grayscale values of the superposed, non-defective pixels. According to a further embodiment, the object can be basically acquired in its entirety in each of the partial X-ray images. According to a further embodiment, each of the two partial X-ray images may be recorded at basically half of the entire target X-ray dose. According to a further embodiment, each of the partial X-ray images can be recorded at basically the fraction of the entire target X-ray dose corresponding to the total number of partial X-ray images. According to a further embodiment, the active pixel matrix can be displaced from the first position into the second position by the displacement after the first partial X-ray image has been recorded and the second partial X-ray image is subsequently recorded. According to a further embodiment, the displacement of the X-ray detector may be calculated on the basis of the distribution of the defective pixels on the active pixel matrix. According to a further embodiment, the displacement may be calculated using a chart of defective pixels of the pixel matrix generated in a calibration step.

According to another embodiment, an X-ray detector may have an active pixel matrix with at least one defective pixel and an apparatus for displacing the active pixel matrix, which X-ray detector is designed to displace the active pixel matrix in the plane thereof by a predetermined displacement by means of the displacement apparatus.

According to a further embodiment of the above X-ray detector, the displacement apparatus can be designed to displace the pixel matrix by an integer multiple of the pixel lengths. According to a further embodiment of the above X-ray detector, the displacement apparatus can be arranged within the housing of the X-ray detector. According to a further embodiment of the above X-ray detector, the displacement apparatus can be driven by stepper motors. According to a further embodiment of the above X-ray detector, the displacement apparatus can be actuated by a piezo-nano-positioning system. According to a further embodiment of the above X-ray detector, the displacement apparatus can be actuated by optical encoders.

According to yet another embodiment, an X-ray system may carry out the above mentioned method and having an X-ray detector as described above and an X-ray source for applying X-ray radiation, a control unit for actuating the recording of partial X-ray images and for actuating a displacement of the active pixel matrix, and an image processing unit for superposing and processing the partial X-ray images to form an X-ray image.

### BRIEF DESCRIPTION OF THE DRAWINGS

The invention and further advantageous refinements according to features of the dependent claims are explained in more detail in the following text on the basis of exemplary embodiments illustrated schematically in the drawing, without this restricting the invention to these exemplary embodiments. In the figures:

FIG. 1 shows a sequence of a method according to an embodiment,

FIG. 2 shows a further sequence of a method according to an embodiment,

FIG. 3 shows a plan view on a pixel matrix of an X-ray detector in a first position,

FIG. 4 shows a plan view on a pixel matrix of an X-ray detector in a second position,

FIG. 5 shows a plan view on a first partial X-ray image recorded in a first position of the active matrix,

FIG. 6 shows a plan view on a second partial X-ray image recorded in a second position of the active matrix,

FIG. 7 shows a view of the two superposed partial X-ray images,

FIG. 8 shows a view of an X-ray detector according to an embodiment and

FIG. 9 shows a side view of an X-ray system according to an embodiment.

### DETAILED DESCRIPTION

The method according to various embodiments for recording an X-ray image of an object by means of an active pixel matrix of an X-ray detector from at least two partial X-ray images, in which a first partial X-ray image is recorded from picture elements in a first position of the pixel matrix and at least one second partial X-ray image is recorded from picture elements in a second position of the pixel matrix, wherein the pixel matrix has at least one defective pixel at a defect site and wherein the positions are selected such that the active pixel matrix is situated in the same plane in all positions, that each displacement of the active pixel matrix from one position into another position is an integer multiple of a pixel length, and that at least one non-defective pixel is positioned in at least one other position at the respective defect sites of all positions, ensures an artifact-free and high-quality imaging of the object. By means of the method according to various embodiments, a real recording of the object is available for each individual pixel at least in one position and so no relevant detail can be lost by interpolation and no falsifying artifact can be created. The method according to various embodiments also allows the use of X-ray detectors with a relatively large number of defective pixels in imaging.

According to an embodiment, a first partial X-ray image is recorded from picture elements in a first position of the pixel matrix and a second partial X-ray image is recorded from picture elements in a second position of the pixel matrix, wherein the two positions are selected such that the active matrix is situated in the same plane in both positions, that a displacement of the active matrix from the first position into the second position is an integer multiple of a pixel length, and that a non-defective pixel from the respective other position is positioned at the defect sites of both positions. Recording precisely two partial X-ray images can be carried out in a simple and quick fashion.

According to a further embodiment, three or more partial X-ray images are recorded. By using an even greater number of partial X-ray images it is possible to compensate for even more defective pixels in an X-ray detector because in this fashion a non-defective pixel has to be present at each site in only respectively one of a plurality of positions.

Advantageously, the picture elements from the first and the second partial X-ray image are superposed displaced by the displacement, that is to say such that the same imaged picture elements of the object lie above one another, and are processed to form the X-ray image. Advantageously for an error-free and artifact-free X-ray image, the processing of the partial X-ray images only utilizes the grayscale values of the non-defective pixels.

According to a further embodiment, the processing of the partial X-ray images performs an averaging of the grayscale values of the superposed, non-defective pixels. This is particularly advantageous if the X-ray dose was distributed evenly over all partial X-ray images. Averaging can also compensate for small inaccuracies in the recording. The picture elements of the defective pixels are not included in the imaging and so a defect-free, high-quality X-ray image can be generated.

Expediently, the object is basically acquired in its entirety in each of the partial X-ray images. This can ensure a complete and error-free imaging of the object when combining the partial X-ray images.

According to an embodiment, each of the two partial X-ray images is recorded at basically half of the entire target X-ray dose. This allows effective compensation of defective pixels because each picture element was recorded at least with half of the entire X-ray dose. According to a further embodiment, if there are more than two partial X-ray images, each of the partial X-ray images is recorded at basically the fraction of the entire target X-ray dose corresponding to the total number of partial X-ray images.

Expediently, the active pixel matrix is displaced from the first position into the second position by the displacement after the first partial X-ray image has been recorded and the second partial X-ray image is subsequently recorded. In the process, it is expedient for the two recordings to be performed as quickly as possible in succession in order to prevent changes or movements of the object between the recordings.

According to a further embodiment, the corresponding displacement of the X-ray detector is calculated on the basis of the distribution of the defective pixels on the active matrix. It is also possible for a number of options to be determined for the displacement. By way of example, the displacement can be calculated by a calculation unit and can subsequently be stored. In all X-ray recordings, the stored displacement is always subsequently used.

Advantageously, the displacement is calculated using a chart of defective pixels of the active matrix generated in a calibration step. The generation of a so-called defect-pixel map is known.

The various embodiments likewise comprise an X-ray detector having an active pixel matrix with at least one defective pixel and having an apparatus for displacing the active pixel matrix, which X-ray detector is designed to displace the active pixel matrix in the plane thereof by a predetermined displacement by means of the displacement apparatus. Such a displacement apparatus can for example be arranged within a housing of the X-ray detector.

Moreover, the various embodiments comprise an X-ray system for carrying out the method, having an X-ray detector and an X-ray source for applying X-ray radiation, a control unit for actuating the recording of partial X-ray images and for actuating a displacement of the active matrix, and an image processing unit for superposing and processing the partial X-ray images to form an X-ray image.

According to an embodiment, the displacement apparatus is designed to displace the active matrix by an integer multiple of the pixel lengths.

Advantageously, the displacement apparatus is driven by stepper motors. According to an embodiment, the displacement apparatus can be actuated by a piezo-nano-positioning system or by optical encoders.

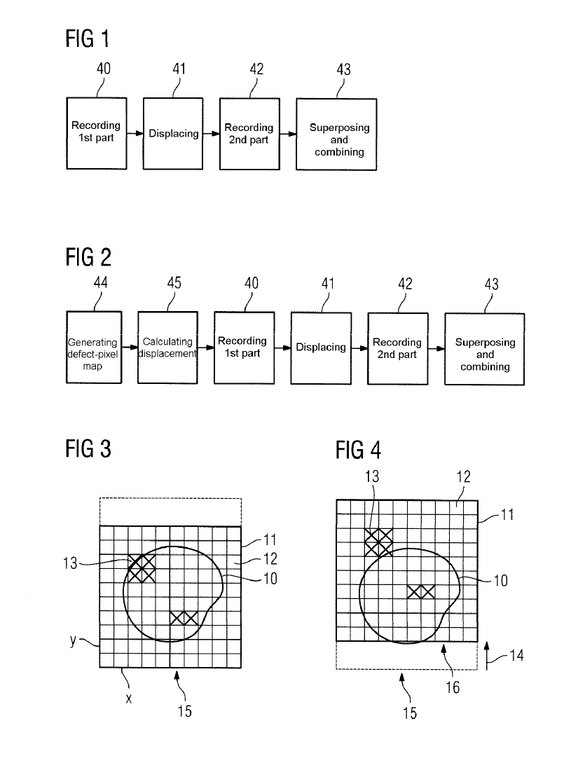

FIG. 1 shows a sequence of a method according to various embodiments for recording an X-ray image of an object by means of an active pixel matrix of an X-ray detector from, for example, two partial X-ray images. In a step 40, a first partial X-ray image of an object is recorded by means of an active matrix of an X-ray detector. The active matrix is in a first position during the recording and a first X-ray dose is used to carry out the recording. Here, the active matrix has at least one defective pixel, wherein the location of the first defective pixel within the matrix is referred to as for example the first defect site. Subsequently, in a step 41, the active matrix of the X-ray detector is moved within the plane thereof by a predetermined displacement into a second position. With respect to the pixels of the active matrix, the displacement can in this case be carried out both in the positive or negative x-direction and, perpendicular thereto, in the positive or negative y-direction, wherein the displacement in each of the two directions in each case is an integer multiple of a pixel length. The displacement can also be carried out in only one of the two directions. What is particularly important is that the displacement is selected such that (e.g. in the case of two positions) there are no defect sites of the second position at the defect sites of the first position and vice versa, but that at least one non-defective pixel of the respective other position is always positioned thereon. This ensures that each point of the object is recorded at least once.

Subsequently, in a step 42, a second partial X-ray image of the object is recorded, whilst the active matrix is in the second position and a second X-ray dose is used in the process. Both partial X-ray images are displaced by the displacement in a step 43, that is to say corresponding picture elements are superposed and combined. This images the object completely. By way of example, the two partial X-ray images are combined such that grayscale values are generated by averaging the grayscale values of both picture elements in the case of two picture elements recorded from non-defective pixels. If one picture element from a defective pixel and one picture element from a non-defective pixel are available, it is only the picture element from the non-defective pixel that is used as grayscale value and it is, if need be, extrapolated according to its component of the entire X-ray dose.

In FIG. 2, additional possible preceding steps are shown in addition to the method sequence according to FIG. 1. In a step 44, a so-called defect-pixel map of the active matrix of the X-ray detector is generated, that is to say a precise chart that shows which pixels of the active matrix are defective. The generation of such defect-pixel maps is known. On the basis of the generated defect-pixel map, a suitable displacement is then determined in a further step 45 and stored, which displacement satisfies the aforementioned criteria. By way of example, the displacement can be calculated by a calculation unit.

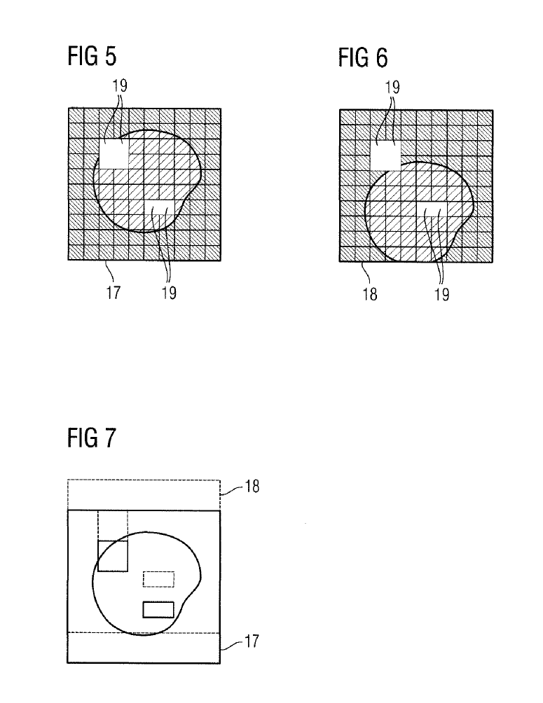

FIGS. 3 to 7 show an active matrix 11 (FIG. 3 and FIG. 4) and the resultant partial X-ray images (FIG. 5 and FIG. 6) and the resultant X-ray image (FIG. 7). Here, the active matrix 11 is shown in its first position 15 relative to the object 10 in FIG. 3. The active matrix 11 has a multiplicity of square pixels 12, which respectively have a first pixel axis x and a second pixel axis y and are accordingly arranged in rows and columns. The pixels generate picture elements, for example in the form of grayscale values, which can then, for example, be displayed on a monitor. A plurality of pixels are formed by defective pixels 13 in an exemplary fashion. Defective pixels generate picture elements with no or incorrect grayscale values. In FIG. 4, the active matrix 11 is shown in its second position 16, wherein the first position 15 is shown by dashed lines. The second position 16 differs from the first position 15 by a displacement 14, which for example consists of two pixel lengths in the direction of the second pixel axis y. The displacement 14 in the direction of only one pixel axis is only selected as a simple example, it could likewise also be in the direction of the first pixel axis x or in both directions. The displacement 14 ensures that two defective pixels never lie on top of one another in both positions and so each point of the object is recorded at least once.

FIG. 5 shows a first partial X-ray image 17 recorded in the first position and FIG. 6 shows a second partial X-ray image recorded in the second position, which images have defective picture elements 19. However, in a superposition of the two partial X-ray images, the defective picture elements never lie on top of one another and so a defect-free X-ray image of the object can be generated.

FIG. 8 shows an X-ray detector 20, which has a housing 22 in which a scintillator 21 and an active matrix 11 are arranged. The scintillator 21 converts X-ray radiation into light and the light is recorded by the active matrix of pixels, each of which has a photodiode, and converted into picture elements. The X-ray detector 20 moreover has a positioning system 23, which can displace the active matrix by an integer multiple of pixel lengths in the direction of the pixel axes. The positioning system 23 is ideally designed to displace the active matrix in a particularly fast and precise fashion, since average pixel lengths are e.g. 150 μm. In a possible embodiment, the positioning system is formed by a piezo-nano-positioning system. Such piezo-nano-positioning systems operate with repeat accuracies in the nanometer range and with very short response times (e.g. below one millisecond). In another embodiment, it is for example possible to use very precise and fast stepper motors. Here, the precision of the positioning can e.g. also be supported by optical encoders (controlled positioning).

In the case of moving objects, there can be an object displacement in addition to the displacement vector. In this case, provision can be made for a correction vector to be calculated by an additional movement recognition unit and for this correction vector to be taken into account when superposing the partial X-ray images.

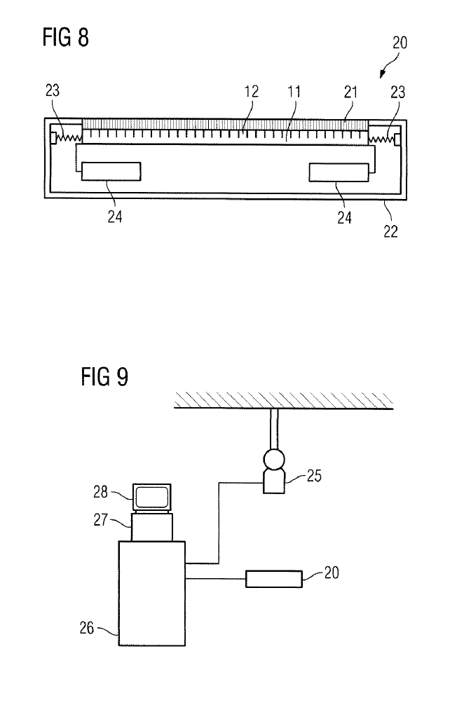

FIG. 9 shows an X-ray system, which has an X-ray source 25 and an X-ray detector 20 with a positioning system 23. The X-ray system is actuated by a system control 26 and has an image processing system 27 and a display unit 28. The system control 26 actuates the X-ray detector to record a first partial X-ray image according to the method according to various embodiments, to displace the active matrix and subsequently to record a second partial X-ray image. At the same time, the system control actuates the X-ray source in each case to emit X-ray radiation of a certain X-ray dose at the same time. The two partial X-ray images are read out from the X-ray detector and are superposed and combined, for example by means of the image processing apparatus.

The resultant X-ray image differs from an X-ray image from a defective-pixel-free X-ray detector by its signal-to-noise ratio at the sites at which there was a defective pixel in one of the two partial X-ray images. At all other positions it corresponds to this latter recording.

In order to compensate for location effects by the applied dose from the first recording, an offset image can be recorded between the recording of the first and the second partial X-ray image.

Thus, it is also possible to record, superpose and combine more than two partial X-ray images, for example three or four partial X-ray images. This allows selection of smaller displacements between the positions and also allows use of X-ray detectors with a very high number of defective pixels.

The various embodiments can briefly be summarized as follows: So that it is also possible to obtain a high-quality X-ray image from X-ray detectors with defective pixels, provision is made for a method for recording an X-ray image of an object by means of an active pixel matrix of an X-ray detector from at least two partial X-ray images, in which a first partial X-ray image is recorded from picture elements in a first position of the pixel matrix and at least one second partial X-ray image is recorded from picture elements in a second position of the pixel matrix, wherein the pixel matrix has at least one defective pixel at a defect site and wherein the positions are selected such that
the active pixel matrix is situated in the same plane in all positions.
each displacement of the active pixel matrix from one position into another position is an integer multiple of a pixel length, and
at least one non-defective pixel is positioned in at least one other position at the respective defect sites of all positions.

What is claimed is:

1. A method for recording an X-ray image of an object by means of an active pixel matrix of an X-ray detector from at least two partial X-ray images, the method comprising:
recording a first partial X-ray image from picture elements in a first position of the pixel matrix and recording at least one second partial X-ray image from picture elements in a second position of the pixel matrix, wherein the pixel matrix has at least one defective pixel at a defect site and wherein the positions are selected such that
the active pixel matrix is situated in the same plane in all positions,
each displacement of the active pixel matrix from one position into another position is an integer multiple of a pixel length, and
at least one non-defective pixel is positioned in at least one other position at the respective defect sites of all positions.

2. The method according to claim 1, wherein a first partial X-ray image is recorded from picture elements in a first position of the pixel matrix and a second partial X-ray image is recorded from picture elements in a second position of the pixel matrix, wherein the two positions are selected such that
the pixel matrix is situated in the same plane in both positions,
a displacement of the pixel matrix from the first position into the second position is an integer multiple of a pixel length, and
a non-defective pixel from the respective other position is positioned at the defect sites of both positions.

3. The method according to claim 1, wherein three or more partial X-ray images are recorded.

4. The method according to claim 2, wherein the picture elements from the first and the second partial X-ray image are superposed displaced by the displacement and are processed to form the X-ray image.

5. The method according to claim 4, wherein the processing of the partial X-ray images only utilizes the grayscale values of the non-defective pixels.

6. The method according to claim 5, wherein the processing of the partial X-ray images performs an averaging of the grayscale values of the superposed, non-defective pixels.

7. The method according to claim 1, wherein the object is basically acquired in its entirety in each of the partial X-ray images.

8. The method according to claim 2, wherein each of the two partial X-ray images is recorded at basically half of the entire target X-ray dose.

9. The method according to claim 1, wherein each of the partial X-ray images is recorded at basically the fraction of the entire target X-ray dose corresponding to the total number of partial X-ray images.

10. The method according to claim 1, wherein the active pixel matrix is displaced from the first position into the second position by the displacement after the first partial X-ray image has been recorded and the second partial X-ray image is subsequently recorded.

11. The method according to claim 6, wherein the displacement of the X-ray detector is calculated on the basis of the distribution of the defective pixels on the active pixel matrix.

12. The method according to claim 11, wherein the displacement is calculated using a chart of defective pixels of the pixel matrix generated in a calibration step.

13. An X-ray detector having an active pixel matrix with at least one defective pixel and having an apparatus for displacing the active pixel matrix, which X-ray detector is designed to displace the active pixel matrix in the plane thereof by a predetermined displacement by means of the displacement apparatus.

14. The X-ray detector according to claim 13, wherein the displacement apparatus is designed to displace the pixel matrix by an integer multiple of the pixel lengths.

15. The X-ray detector according to claim 13, wherein the displacement apparatus is arranged within the housing of the X-ray detector.

16. The X-ray detector according to claim 13, wherein the displacement apparatus is driven by stepper motors.

17. The X-ray detector according to claim 15, wherein the displacement apparatus can be actuated by a piezo-nano-positioning system.

18. The X-ray detector according to claim 15, wherein the displacement apparatus can be actuated by optical encoders.

19. An X-ray system comprising an active pixel matrix with at least one defective pixel and having an apparatus for displacing the active pixel matrix, which X-ray detector is designed to displace the active pixel matrix in the plane thereof by a predetermined displacement by means of the displacement apparatus and an X-ray source for applying X-ray radiation, a control unit for actuating the recording of partial X-ray images and for actuating a displacement of the active pixel matrix, and an image processing unit for superposing and processing the partial X-ray images to form an X-ray image, wherein the X-ray system is operable to
record a first partial X-ray image from picture elements in a first position of the pixel matrix and to record at least one second partial X-ray image from picture elements in a second position of the pixel matrix, wherein the pixel matrix has at least one defective pixel at a defect site and wherein the positions are selected such that
the active pixel matrix is situated in the same plane in all positions,
each displacement of the active pixel matrix from one position into another position is an integer multiple of a pixel length, and
at least one non-defective pixel is positioned in at least one other position at the respective defect sites of all positions.

20. The X-ray system according to claim 19, wherein the displacement apparatus is designed to displace the pixel matrix by an integer multiple of the pixel lengths and wherein the displacement apparatus is arranged within the housing of the X-ray detector.
